(19) United States
(12) Patent Application Publication
(10) Pub. No.: US 2007/0088507 A1
(43) Pub. Date: Apr. 19, 2007

(54) Systems and methods for automating environmental risk evaluation

(76) Inventors: James Haberlen, Manhattan Beach, CA (US); Jon Walker, Fairfield, CT (US); Paul Schiffer, Ridgefield, CT (US); Tom Henry Klinger, Stratford, CT (US)

Correspondence Address: MORGAN LEWIS & BOCKIUS LLP, 1111 PENNSYLVANIA AVENUE NW, WASHINGTON, DC, 20004, US

(21) Appl. No.: 11/250,811

(22) Filed: Oct. 13, 2005

(51) Int. Cl. G06F 19/00; G06Q 40/00

(52) U.S. Cl. 702/19; 705/38

(57) ABSTRACT

Aspects of the present invention comprise systems and methods for conducting automatically generated environmental risk evaluations for properties. A computerized method preferably uses known data of property records and compares those properties to environmental evaluation factors according to rules contained in environmental scoring databases to produce a risk report comprising a risk score, findings, and a property timeline.

### CROSS-REFERENCE TO RELATED APPLICATIONS

This application claims priority to U.S. Provisional Patent App. No. 60/618,284, filed Oct. 12, 2004. The entire contents of that provisional application are incorporated herein by reference.

### BACKGROUND

In the United States, property may become environmentally contaminated due to activities on the property or on surrounding properties through contaminant migration. Such activities may have occurred recently or far in the past, and such activities may have involved chemical processes, spills, or other toxic contamination that may not have been remediated. Government and business may respond in a variety of ways to known or potential contamination, including lawsuits, a professional investigation leading to an opinion, insurance policies, remediation of contamination, or drafting legislation. Various methods have been developed by business and government to predict and/or control the effects of known or potential environmental contamination. Common methods of property environmental due diligence have been codified under the ASTM E1527 Standard Practice for Environmental Site Assessments: Phase 1 Environmental Site Assessment Process, and promulgated by the United States Government under 40 CFR Part 312 Standards and Practices for All Appropriate Inquiries. These methods generally involve a manual review by a certified professional of many databases of property information and a manual comparison of properties and property features such as chemical storage facilities, age, construction type, current and historical property use, potential or known contamination, and others to databases of evaluation factors such as geography, geology, groundwater, elevation, soil composition, chemical types, health risks, building composition, and others, in order for the professional to form an opinion of the risk of environmental contamination at a property.

Presently available methods are designed to meet common environmental due diligence industry standards, but business needs often call for other solutions to environmental risk that are faster and less expensive than currently available methods. In addition, some businesses have determined that the common methods for environmental risk evaluations do not apply to day-to-day business risks; consequently, some businesses find a computer automatically generated environmental risk evaluation a suitable solution to various problems associated with environmental contamination.

### SUMMARY

Many software solutions to the problems of environmental risk produce only a YES or NO recommendation. The present invention is distinguished, in one aspect, by its ability to provide a numeric score (for example, a score from 0 to n; n any nonzero real number) that can either be presented directly as a numeric score or, if desired, converted, for example, to a HIGH RISK or LOW RISK recommendation based on preset customer risk tolerance thresholds input with each order. Further, in one aspect, the invention combines the score with an automatically generated timeline of the environmental risks that contributed to the score drawn from current and historical data.

An object of the present invention is to provide an efficient system for assigning an environmental risk evaluation to one or more properties.

Another object of the present invention is to provide an automatically generated process that requires minimal human intervention (other than setting system parameters) to perform environmental risk evaluation.

Another object of the present invention is to incorporate many evaluation factors and compare those evaluation factors to property records.

Another object of the present invention is to incorporate a database of records describing a risk score to be calculated after comparing records.

Another object of the present invention is to provide a report of the results of the automatically generated risk evaluation.

The above and other objects of the invention are realized through a system that preferably uses software installed at a server to filter records based on evaluation factors.

Other than setting system parameters, loading the raw records into property records databases, and periodic maintenance, a preferred embodiment of the invention may be run without human intervention.

Property environmental risk is often generally understood as analyzing, on the one hand, potential negative effects due to environmental contamination such as cleanup costs and/or property devaluation and, on the other hand, the ability to pay for cleanup as well as financial profits associated with property ownership. Since each customer and each property report order will have different risk tolerance thresholds due to factors such as financial assets, loan-to-value ratios, property type and financial benefits, and location, a numeric risk scoring process provides a computational method that allows customers to more precisely evaluate risk.

The invention has specific advantages over other more limited systems by creating a risk score from 0 to n , based on one or more current and historical factors, that can, if desired, be converted, based on customer risk tolerances, to a binary “HIGH RISK” or “LOW RISK” representation recommendation, or to one of a plurality of risk levels (e.g., MEDIUM RISK, MEDIUM LOW RISK, etc.). Other, more limited methods use fewer risk factors, include manual review, and do not allow for a computation based on multiple factors. Further, a preferred embodiment of this invention combines an automatically generated risk score with an automatically generated timeline of environmental risks to enable a faster and more comprehensive review of risks than other more limited systems.

In one aspect, the present invention comprises a computer-implemented method for providing property information, comprising the steps of: (a) electronically receiving a request for environmental information regarding a target property, wherein the request includes data sufficient to identify the target property; (b) electronically searching a plurality of databases for environmental information regarding the target property and other properties located within one or more pre-determined distances of the target property; (c) electronically storing environmental and identifying information found in the databases related to the target property and other properties within one or more pre-determined distances of the target property; (d) electronically evaluating the stored information to identify environmental risk factors relating to the target property and each of the other properties; (e) electronically calculating one or more preliminary scores, one for the target property and one for each of the other properties; and (f) electronically calculating a risk score for the target property based on one or more preliminary scores. Advantageously, each of the foregoing steps is performed by a computer under control of a computer program.

In various embodiments of the invention, the following elements may be present in various combinations: (1) the request is received over a computer network; (2) the method further comprises displaying a risk-level categorization based on the risk score; (3) the method further comprises calculating an adjusted score for the target property and each of the other properties, wherein each adjusted score is based on a corresponding preliminary score and wherein the risk score is further based on the adjusted scores; (4) the risk-level categorization is further based on one or more pre-determined risk tolerance thresholds; (5) the method further comprises displaying the risk score for the target property; (6) the environmental and identifying information comprises data regarding creation dates for information sources for the databases; (7) the environmental and identifying information comprises historical data regarding the target property or the other properties; (8) the evaluating step comprises comparison of the stored information to one or more environmental risk tables; (9) the environmental risk table comprises columns, and wherein each column corresponds to a pre-determined distance from a generic target property; (10) the preliminary scores are based at least in part on numerical values in the columns; (11) at least one of the environmental risk tables comprises rows, and wherein each of the rows corresponds to a database; (12) at least one of the environmental risk tables comprises rows, and wherein each of the rows corresponds to a keyword; (13) the adjusted score for each property is based at least in part on the site status of one or more environmental risk factors for that property (site status including, for example, remediated, under remediation, closed, etc.); (14) the adjusted score for each property is based at least in part on a comparison of elevation of that property to elevation of the target property; (15) the adjusted score for each property is based at least in part on soil and geologic characteristics for that property; (16) the adjusted score for each property is based at least in part on health risks for that property; (17) the adjusted score for each property is based at least in part on historical factors regarding that property; (18) the evaluating step comprises calculating a probability or range of probabilities regarding one or more of the factors; and/or (19) the adjusted score is based at least in part on estimated costs.

In another aspect, the invention comprises computer software for providing property information, comprising: software for electronically receiving a request for environmental information regarding a target property, wherein the request includes data sufficient to identify the target property; software for electronically searching a plurality of databases for environmental information regarding the target property and other properties located within one or more pre-determined distances of the target property; software for electronically storing environmental and identifying information found in the databases related to the target property and other properties within the one or more pre-determined distances of the target property; software for electronically evaluating the stored environmental and identifying information to identify environmental risk factors relating to the target property and each of the other properties; software for electronically calculating one or more preliminary scores, one for the target property and one for each of the other properties; and software for electronically calculating a risk score for the target property based on the one or more preliminary scores.

In another aspect, the invention comprises a computer system programmed to: receive a request for environmental information regarding a target property, wherein the request includes data sufficient to identify the target property; search a plurality of databases for environmental information regarding the target property and other properties located within one or more pre-determined distances of the target property; store environmental and identifying information found in the databases related to the target property and other properties within the one or more pre-determined distances of the target property; evaluate the stored environmental and identifying information to identify environmental risk factors relating to the target property and each of the other properties; calculate one or more preliminary scores, one for the target property and one for each of the other properties; and calculate a risk score for the target property based on the one or more preliminary scores.

Other aspects of the invention will be apparent to those skilled in the art after reading the description below.

The foregoing features and advantages of the invention may be more fully appreciated by reference to a specific embodiment thereof, as described below in conjunction with the following figures.

### BRIEF DESCRIPTION OF THE DRAWINGS

FIG. 1 is a flowchart illustrating software of the preferred embodiment that generates an Environmental Evaluation Score Report. The flowchart begins with “Take Order.” For the Order, the software collects Property Records from documented sources, assigns Environmental Evaluation Scores to the Property Records, and generates the Environmental Evaluation Score Report. The process ends with “Deliver Order.”

FIG. 2 is a flowchart showing preferred Environmental Data Collection and Environmental Evaluation Score processes, wherein the Property Records for the order are collected and screened, and the findings scored. The results are stored in the Findings with Environmental Evaluation Scores database table.

FIG. 3 is a flowchart showing the processes wherein the Evaluation Scores receive additional adjustments and are compared to each other. The results are stored in the Adjusted Environmental Evaluation Scores table.

FIG. 4 is a flowchart showing the processes wherein the Findings from the Adjusted Environmental Evaluation Scores are compiled to create the Environmental Evaluation Score Report.

FIG. 5 shows data from the Environmental Risk table comparing a property database type to a distance measurement to compute a score. For example, a Property Record with Property Database Acronym “AWP” located between one quarter mile and one half mile from the Order Property is assigned an Environmental Evaluation Score of “0.5”.

FIG. 6 shows data from the Fire Insurance Keyword Table which associates a score with each Property Use or Feature.

FIG. 7 shows data from the City Directory keyword table which associates a score with each Property Use or Feature.

FIG. 8 is a sample System for Comparing Data with a property factor type (contaminated property database) compared to a plurality of Evaluation Factors (distance, elevation, status) resulting in a score.

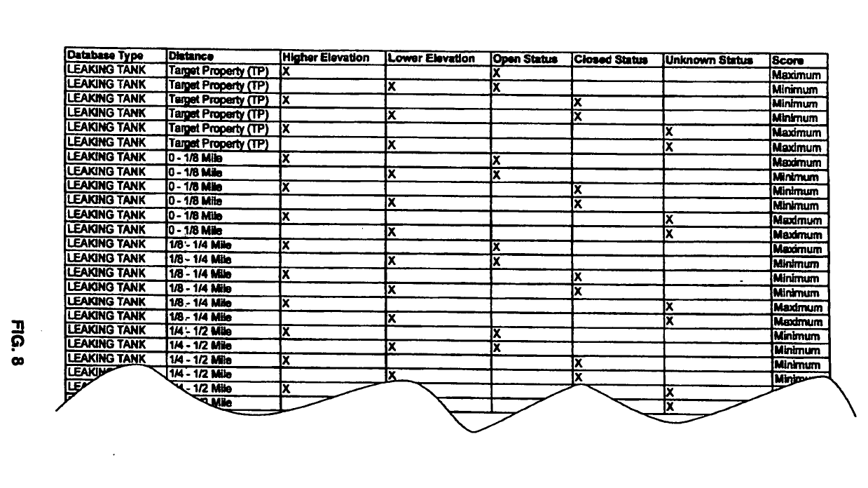

FIG. 9 is a sample of the Summary Page preferred report for the environmental evaluation risk score, converted to a HIGH RISK or LOW RISK.

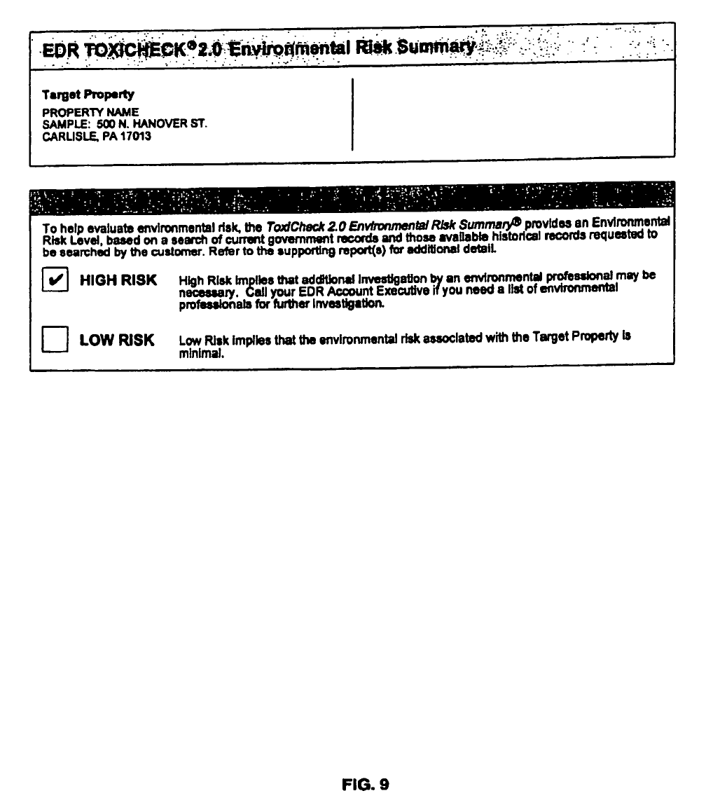

FIG. 10 is a sample of the preferred report for the Findings for Order Property (Target Property) and Findings for Adjoining Properties (Surrounding Properties).

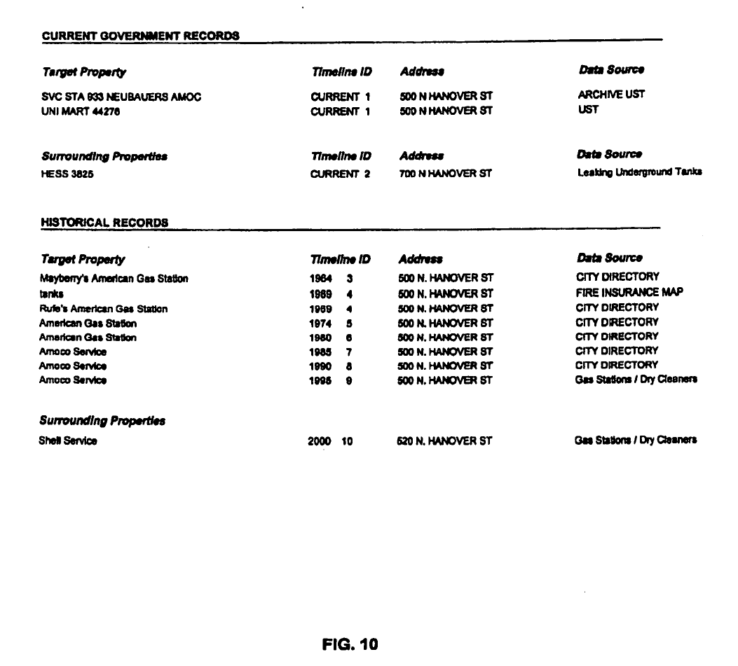

FIG. 11 is a sample Property Timeline of the dates of the property findings.

FIG. 12 is a flowchart showing the collection of Property Records, collection of Evaluation Factors, and their comparison in the system according to rules set by the Evaluation Factors Scoring Tables.

FIG. 13 is an exemplary chart showing score fraction as a function of distance.

### DETAILED DESCRIPTION OF PREFERRED EMBODIMENTS

The present invention preferably is implemented on one or more computer systems in communication with a plurality of databases. The invention comprises software and software-implemented processes for constructing, in an automatically generated manner, reports regarding environmental factors affecting a specified property.

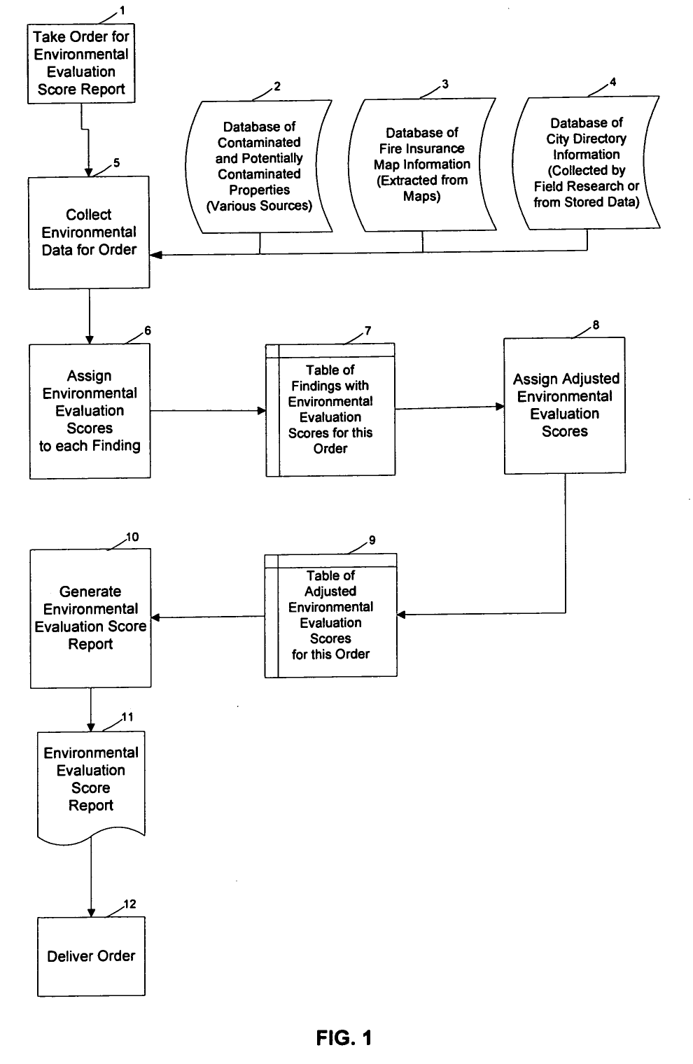

FIG. 1 provides an overview of major elements and steps of preferred software processes. The steps and components described below are merely intended to illustrate preferred embodiments of the invention and none, taken individually, should be construed as essential to the invention. The claims alone define the scope of the invention.

The paragraph numbers below refer to elements depicted in the figures.

1. Take Order for Environmental Evaluation Score Report. This is the first step in a preferred process. The Order includes information that is used to collect environmental data for the report. Information includes Property name, Property address, Property type, and location (which preferably is indicated in latitude and longitude coordinates).

2. The Database of Contaminated and Potentially Contaminated Properties contains information about Contaminated and Registered Properties collected from Federal, State and Local government databases and other property databases, including contaminated sites, potentially contaminated sites, registered sites, and others.

3. The Database of Fire Insurance Map Information contains information collected from Historical Maps. The database is created by those skilled in the art of reviewing hardcopy or electronic Historical Fire Insurance Maps and abstracting text and symbols from the map and converting that information into a database. This review process preferably involves researching available Fire Insurance Maps, reading the maps, and entering information available on the maps into a database. Information commonly abstracted from maps includes property location, property type, and property features. Those skilled in the art of map review may apply this process to any map. Of particular interest is the property use and the property features such as on-site tanks. The database also may contain (for example): Property name, Property address, Property type, Source, and Map Year.

4. The Database of City Directory Information contains information about Historical Properties collected from historical archive databases including City Directories and business directories. The database preferably is created by those skilled in the art of reviewing hardcopy or electronic City Directories or Business Directories and abstracting text and converting that information into a database. This process preferably involves researching available City Directories, locating properties in the City Directory, and entering information available in the City Directory into a database. Information commonly abstracted includes property address, business name, type of business, owner, or resident name. Those skilled in the art of historical document review may apply this process to any City Directory, Street Directory or Business Directory.

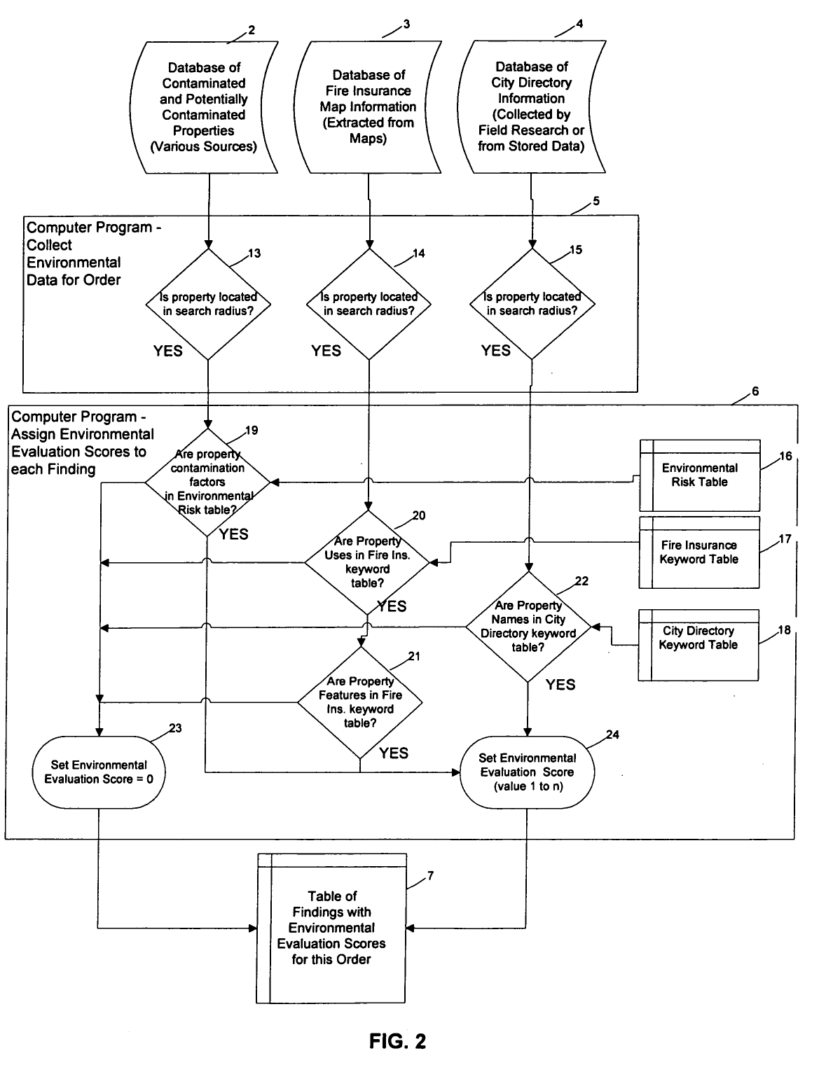

5. Information from the above Databases is collected by the process to Collect Environmental Data for the Order (see also FIG. 2), which also collects Property Records for properties within the search distances defined for this Order and forwards that information to:

6. The process to Assign Environmental Evaluation Scores to Findings (also see FIG. 2). Property Records are assigned an Environmental Evaluation Score based on a collection of Evaluation Risk Factors, and the result is stored in:

7. The Table of Findings with Environmental Evaluation Scores for this Order. That information is used by:

8. The process to re-evaluate Environmental Scores and Assign Adjusted Environmental Evaluation Scores. The results are stored in:

9. The Table of Adjusted Environmental Evaluation Scores for this Order, and that information is used by:

10. The process to Generate the Environmental Evaluation Score Report, which organizes and presents the findings. This process creates:

11. The Environmental Evaluation Score Report. Upon completion,

12. The process to Deliver the Order sends the final product to complete the Order.

FIG. 2 provides a detailed view of preferred Processes 5 and 6:

13. The Property Records from the Database of Contaminated and Potentially Contaminated Properties are evaluated to locate the Property Records for properties within the search distances defined for this Order. Selected records are passed to The Process to Assign Environmental Evaluation Scores (6).

14. The Property Records from the Database of Fire Insurance Map Information are evaluated to locate Property Records for properties within the search distances defined for this Order. Selected records are passed to The Process to Assign Environmental Evaluation Scores (6).

15. The Property Records from the Database of City directory Information are evaluated to locate Property Records for properties within the search distances defined for this Order. Selected records are passed to The Process to Assign Environmental Evaluation Scores (6).

16. In The Process to Assign Environmental Evaluation Scores for the Order (6), the Environmental Risk Table contains a collection of Evaluation Factors used to score Contaminated and Potentially Contaminated Property Records.

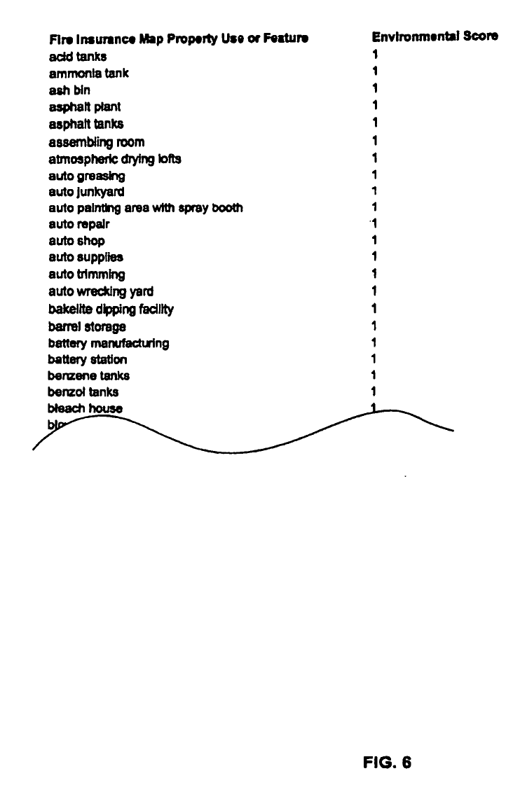

17. The Fire Insurance Keyword Table is used to assign Environmental Evaluation Scores by the occurrence of keyword(s) in the Property Use and Property Features of the Property Record. Scores may vary according to the type of keyword. For example, a “commercial property” may have a different score than an “underground gas tank.” (See FIG. 6.)

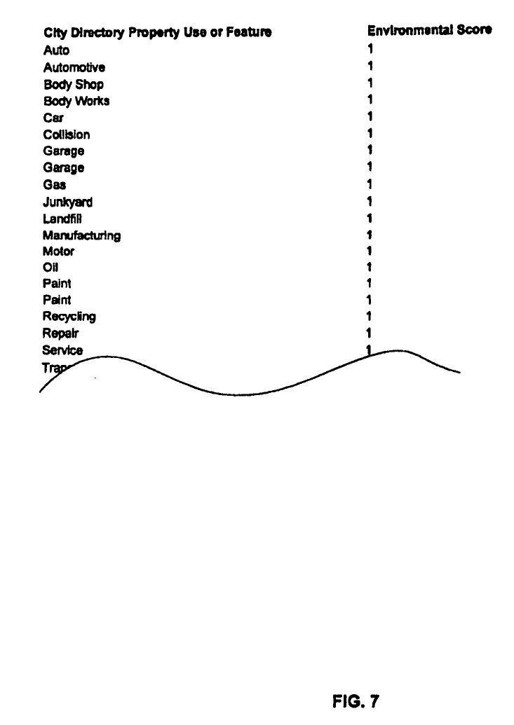

18. The City Directory Keyword Table is used to assign Environmental Evaluation Scores by the occurrence of keyword(s) in the Property Name of the Property Record. Scores may vary according to the type of keyword. For example, a “manufacturer” may have a different score than a “gas station.” (See FIG. 7.)

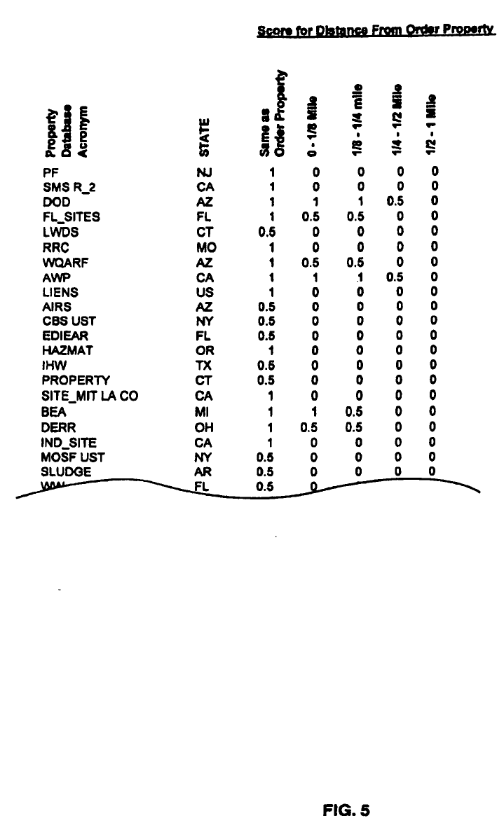

19. At step 19, the Property Records from the Database of Contaminated or Potentially Contaminated Properties are evaluated using the evaluation factors in the Environmental Risk Table (16). The Property Records are assigned an Environmental Evaluation Score of 0 to n. For example, using the sample Environmental Risk Table in FIG. 5, a Property Record with Property Database Acronym “AWP” located between one quarter mile and one half mile from the Order Property is assigned an Environmental Evaluation Score of “0.5.” The process is repeated until all of the Property Records have been assigned an Environmental Evaluation Score.

20. At step 20, the Property Records from the Database of Fire Insurance Map Information are evaluated by comparing the Property Uses to the Factors in the Fire Insurance Keyword Table (17) (see FIG. 6). The Property Records are assigned an Environmental Evaluation Score of 0 to n.

21. At step 21, the Property Records from the Database of Fire Insurance Map Information are evaluated by comparing the Property Features to the Factors in the Fire Insurance Keyword Table (17) (see FIG. 6). The Property Records are assigned an Environmental Evaluation Score of 0 to n.

“Use” refers to what the property is generally used for, e.g. “gas station,” “factory,” “dwelling,” etc. “Feature” refers to something on the property, e.g. “fire escape,” “asbestos,” “oil tank,” etc.

22. At step 22, the Property Records from the Database of City Directory Information are evaluated by comparing the Property Names to the Factors in the City Directory Keyword Table (18). (See FIG. 7.) The Property Records are assigned an Environmental Evaluation Score of 0 to n.

In alternate embodiments, the system may vectorize the Fire Insurance Map collection, and thereby convert the scanned maps to a set of GIS lines, text, and other (potentially numeric) attributes. In that case, a search for “gas tanks” could rely on searching for a numeric code in a GIS database that represents “gas tanks,” rather than the specific keyword “gas tanks.” The system also may include searching “raster” scanned Fire Insurance Map images using GIS technology, using optical character recognition or similar technologies, or using manual methods with subsequent entry into a database searched by electronic systems. The system also may include searching printed Fire Insurance Map images using GIS technology, using optical character recognition or similar technologies, or using manual methods with subsequent entry into a database searched by electronic systems. Other historical databases searchable by some means other than, or in addition to, keyword searching also may be used. “GIS” refers to “Geographic Information Systems,” which provides a technology used to view and analyze data from a geographic perspective. See GIS.com.

23. Set the Property Record Environmental Evaluation Score equal to 0 and store in the Table of Findings with Environmental Scores for this Order (7).

24. Set the Property Record Environmental Evaluation Score value (1 to n real numbers) and store in the Table of Findings with Environmental Scores for this Order (7).

In Step 23-24, “set” means to “store” - e.g., “store in a table”, or “store in memory.” Steps 19-22 have done the lookup and collected the score from the lookup tables. Thus, the “setting” is based on the lookups from 19-22. Step 23 and 24 store the scores and move them into the “Table of Findings with Environmental Evaluations for this Order.”

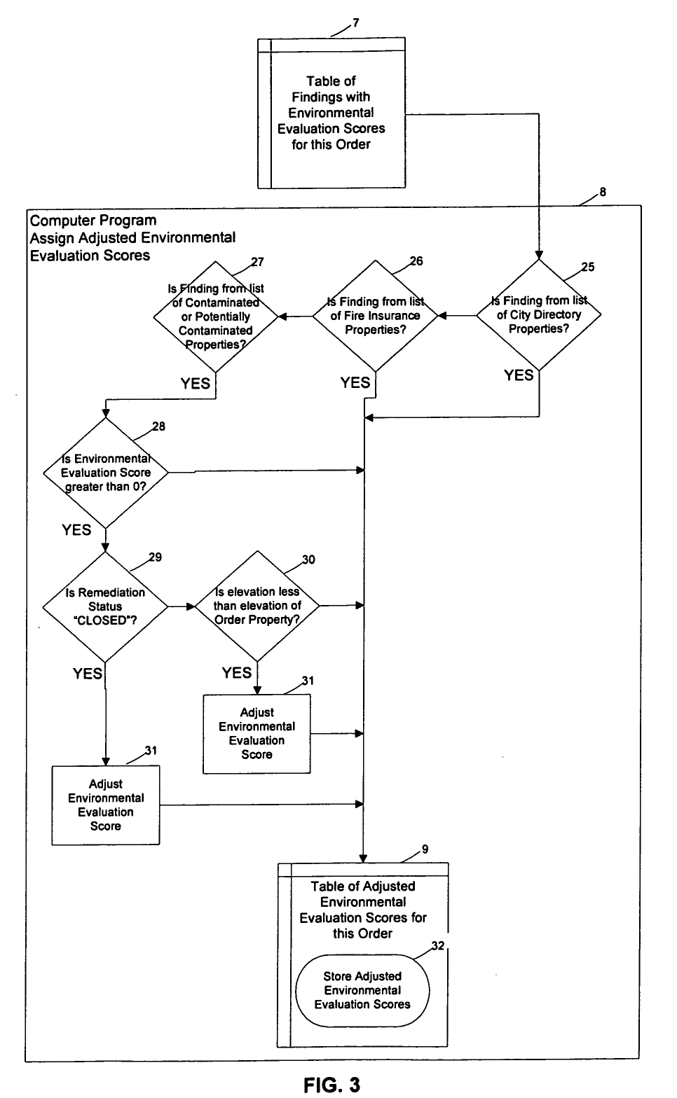

As depicted in FIG. 3, in a preferred embodiment Environmental Evaluation Findings Scores are re-evaluated, assigned adjusted scores, and then compared to derive Final Environmental Evaluation Scores for the Order (Processes 8 and 9).

25. In step 25, the City Directory Property Records from the Table of Findings with Environmental Scores for this Order (7) are added to the Table of Adjusted Environmental Evaluation Scores for this Order (9).

26. In step 26, the Fire Insurance Property Records from the Table of Findings with Environmental Scores for this Order (7) are added to the Table of Adjusted Environmental Evaluation Scores for this Order (9).

According to FIG. 3, step 25 adds the City Directory finding first. Thus, the initial value of “Table of Adjusted Environmental Evaluation Scores for this Order” =0. Step 26 will add to the value from the preceding step 25. Step 27-31 and subsequent iterations of the process depicted in FIG. 3 add to the previous sums.

27. In step 27, the Contaminated or Potentially Contaminated Property Records from the Table of Findings with Environmental Scores for this Order (7) are re-evaluated.

28. In step 28, the Property Records with Environmental Evaluation Scores greater than 0 are passed to step 29.

29. In step 29, for Property Records with Remediation Status=CLOSED, the Environmental Evaluation Scores are passed to Step 31 for adjustment.

30. In step 30, for Property Records with a site elevation less than the elevation at the Order Property, the Environmental Evaluation Scores are passed to Step 31 for adjustment.

31. In step 31, the Environmental Evaluation Score for the designated Property Records is adjusted down by a calculated value. For example: Adjusted Score=Env. Eval. Score minus one half the difference between maximum score for this order and minimum score for this order. (or AS=EES - (max-min)/2 ). The adjusted score is stored in the Table of Adjusted Environmental Evaluation Scores for this Order (9).

Step 31 is describes a comparison of two or more property records from the collection of “contaminated or potentially contaminated properties,” not from the Fire Insurance of City Directory collections. In the process depicted in FIG. 3, if the record is from City Directory (step 25) or Fire Insurance (step 26), the process skips step 31.

Since the entire process loops as long as there are records, a collection of “contaminated or potentially contaminated properties” will be stored in the “Table of Findings with Environmental Evaluations for this Order.” Those records can be compared in Step 31.

32. The Environmental Evaluation Score is stored in the Table of Adjusted Environmental Evaluation Scores.

FIG. 3 represents just one possible embodiment of the invention for adjusting scores. Those skilled in the art of environmental evaluation may apply different scoring calculations to different databases, without departing from the method of the present invention. Scoring processes may be also applied to Fire Insurance Map Databases, City Directory Databases and other databases. For example: historical scores from the City Directory and Fire Insurance Map keyword scoring process, in a different embodiment, may be adjusted by factors related to the date of the primary source publication date—for instance, older records may have a different score than more recent records. In another embodiment, historical scores may be adjusted by factors related to the feature that is scored—for instance, a historical “commercial structure” may have a different score than a historical “underground gas tank.”

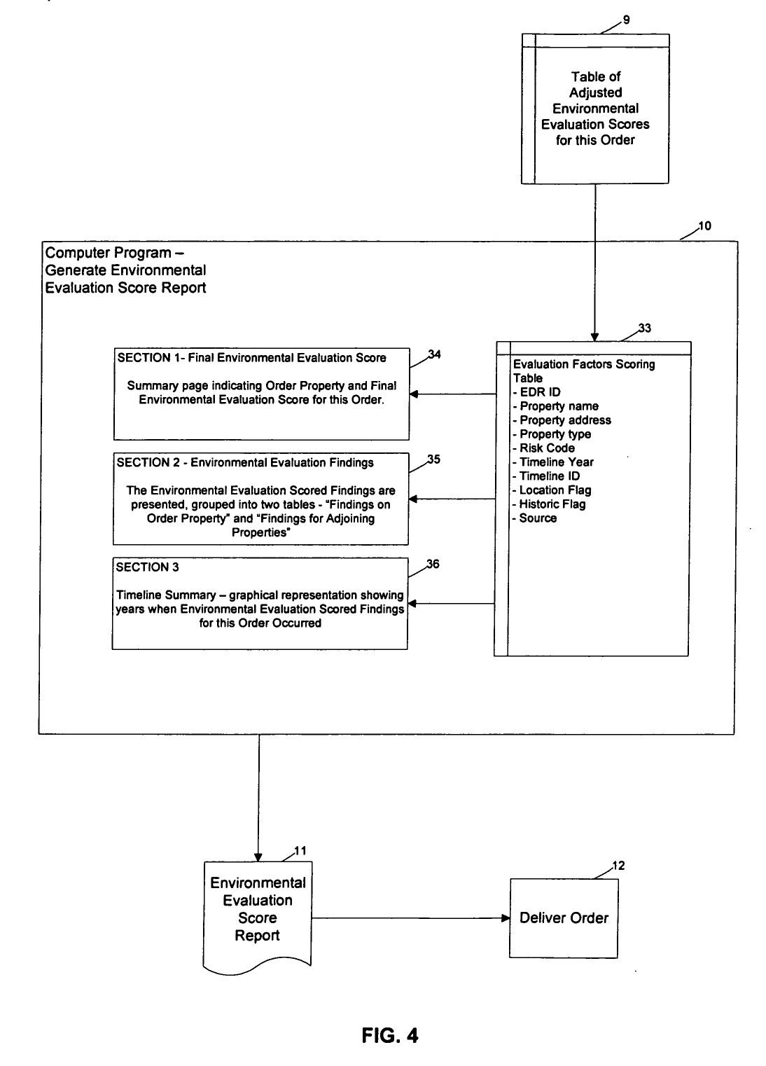

As depicted in FIG. 4, Adjusted Environmental Evaluation Scores for this Order are preferably passed to a computer program component to generate an Environmental Evaluation Score Report (10).

33. Property Records from the Table of Adjusted Environmental Evaluation Scores are sorted into the Evaluation Factors Scoring Table. The Property Findings are grouped into two categories—“Findings for the Order Property” and “Findings for Adjoining Properties.” For each category, the Property Findings are sorted by date. For each category, the sorted Property Records are grouped into clusters and assigned a Time Line ID. The Time Line IDs are assigned from most recent year to least recent year (example, 2004 to 1955).

34. The Property Findings in the Evaluation Factors Scoring Table are compared to derive the Final Environmental Evaluation Score. For example: the Final Environmental Evaluation Score may be set to be the average of the top quartile of Environmental Evaluation Scores for this Order. The process also generates the Summary Page for this Order.

35. Beginning with the second page in the report, the Property Findings in the Evaluation Factors Scoring Table are presented in two categories—“Findings for the Order Property” and “Findings for Adjoining Properties.”

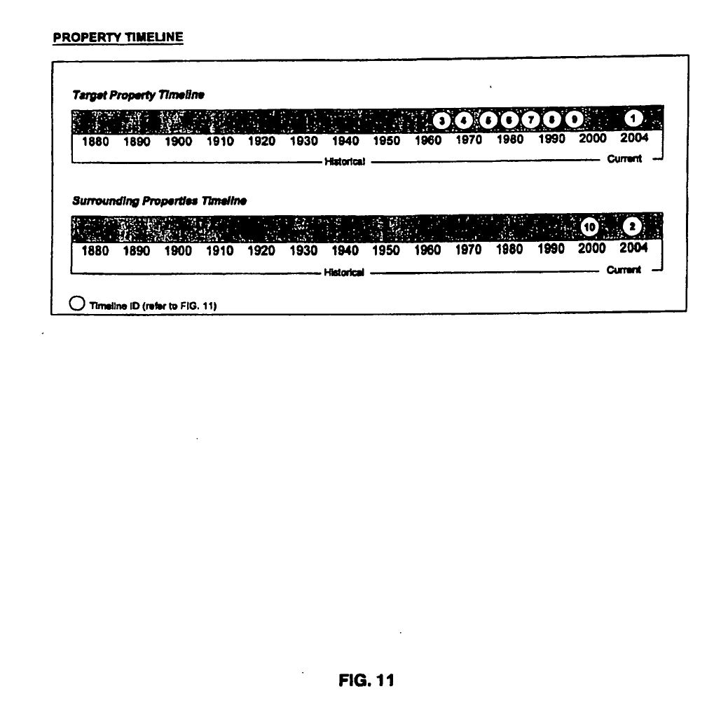

36. An optional Time Line Graph (see FIG. 11), which in this example includes years from 1880 to the current year, has numbered symbols indicating years for which Property Findings were collected for this Order. The number with the symbol on the Time Line Graph is the Time Line ID that was assigned to the Property Record in Process 33. The three sections are presented in the Environmental Evaluation Score Report (10). The Report is then delivered and the Order is complete.

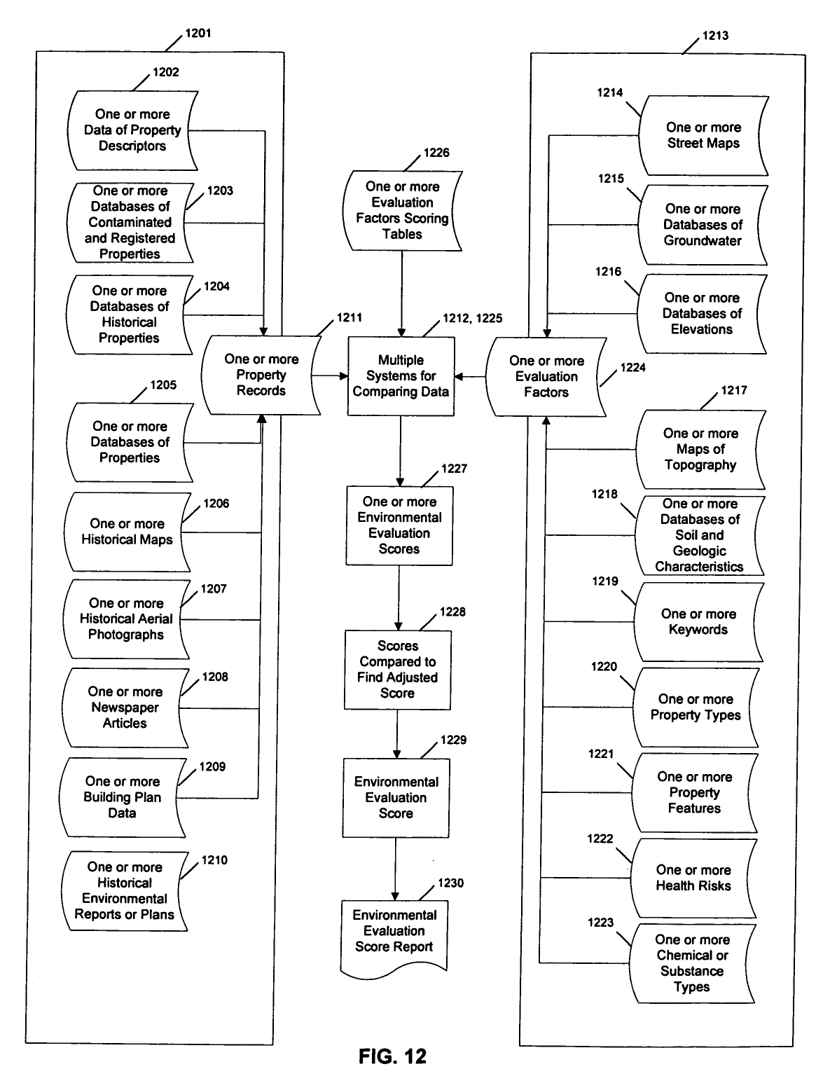

Various aspects of the invention may be practiced using one or more of the elements depicted in FIG. 12.

1201. Property Records collected from a wide variety of databases preferably including, but not limited to:

1202. One or more Property Descriptors supplied with a report request: such as risk tolerance of the customer, building composition and size, features of the loan such as loan-to-value ratio, size of loan, and credit score;

1203. One or more Contaminated and Registered Properties collected from Federal, State and Local government databases of sites, including contaminated sites, potentially contaminated sites, registered sites, and others;

1204. One or more Databases of Historical Properties collected from historical archive databases including City Directories, business directories, proprietary historical data, government files, and others;

1205. One or more Databases of Properties collected from other property databases;

1206. One or more Historical Maps such as Fire Insurance, Platt Maps, Zoning Maps and other maps;

1207. One or more Historical Aerial Photographs, including both recent and historical aerial photographs;

1208. One or more newspaper articles and references collected from current and archived news articles;

1209. One or more Building Plans collected from state agencies, building owners or operators, or others;

1210. One or more Historical Environmental Reports or Plans. Preferably,

1211. One or more Property Records are collected from those listed above, stored in a data system, and input into:

1212. One or more Systems for Comparing Data, the records are stored for further comparison. Also, again preferably,

1213. One or more Evaluation Factors is collected, preferably including, but not limited to:

1214. One or more electronic and hardcopy street maps to locate properties.

1215. One or more Databases of Groundwater to indicate groundwater flow velocity, depth, and direction.

1216. One or more Databases of Elevations to assess topography.

1217. One or more Maps of Topography to assess topography.

1218. One or more Databases of Soil and Geologic Characteristics to compute depth and velocity of liquid migration.

1219. One or more Keywords related to environmental risks, facility types, property characteristics, and others.

1220. One or more Property Types such as “commercial,” “residential,” “warehouse,” “industrial,” etc.

1221. One or more Property Features such as number of stories, tanks on site, building construction type, etc.

1222. One or more Health Risks, both known and potential related to environmental factors, as well as age, gender, historical data, and disease rates.

1223. One or more Chemical or Substance Types. Preferably,

1224. One or more of the above-listed Evaluation Factors are stored and input into one or more Systems for Comparing Data. Then,

1225. One or more Systems for Comparing Data compares the Property Records to the Evaluation Factors and computes a score in a range from 0 to n (real numbers) by reference to:

1226. One or more Evaluation Factor Scoring Tables containing preset parameters of comparison and scoring rules.

1227. The result is stored in One or more Environmental Evaluation Scores databases.

1228. One or more Environmental Evaluation Scores are then Compared to Find Adjusted Scores. Then,

1229. A final Environmental Evaluation Score of 0 to n (real numbers - not necessarily integers) is computed for the report.

1230. The Environmental Evaluation is then presented in a report with the Score, the Current and Historical Property Findings and the Current and Historical Property Timeline.

### EXAMPLE:

Target property (TP) is a residential property, with no identified risk factors. There is a former gasoline station (GS) 1/2 mile away, and a former battery factory (BF) 1/2 mile away. TP has a higher elevation than the GS, but a lower elevation than the BF.

Both GS and BF are found when searching appropriate databases for properties within one mile of TP (e.g., in a database of contaminated and potentially contaminated properties). The GS and BF property records are evaluated using factors listed in the Environmental Risk Table. GS is found in database SITE_MIT LA CO (see FIG. 5) and BF is found in database AWP. Both databases are current government databases, and both properties have a site status equal to “remediated.”

Thus, the Environmental Evaluation Score (EES) for TP is 0, the score for GS is 0 (see column 4, row SITE_MIT LA CO in FIG. 5), and the score for BF is 0.5 (see column 4, row AWP in FIG. 5). Thus, the table of findings with environmental evaluation scores has two items: GS, with a score of 0, and BF, with a score of 0.5.

The Adjusted EES (AEES) for AEES for GS is 0, and the AEES for BF is 0.25 (remediation status is closed, elevation is not less than that of TP; see FIG. 3 and associated text) (note that the formula used here—see step 31 above—is solely intended as an example; those skilled in the art will recognize that other formulas also could be used in this step without departing from the scope and spirit of the present invention). These values are stored in the table of adjusted environmental evaluation scores.

Proceeding to step 34 above, the Final Environmental Evaluation Score will be (using the exemplary formula) 0.25, and this score is reported as the score for TP.

In another embodiment, probability and decision trees are used in conjunction with the above embodiments. That is, the software takes decision trees and scores, and outputs probabilities that can be converted to a final score.

The major steps involved are:

1. Compare records from databases.

2. Link records that share the same address.

3. Prioritize the records found for the same address.

4. Perform scoring evaluation from scoring tables (e.g. status, elevation) (see first and second columns in Table A below).

5. Scoring evaluations may use probability matrices (see fourth column in Table A below).

6. One or more probabilities (fractions) are multiplied to create a final probability or score.

7. Expected costs may be computed by multiplying a New Score with a Cost Estimate. A range of expected costs also may be computed using probability methods.

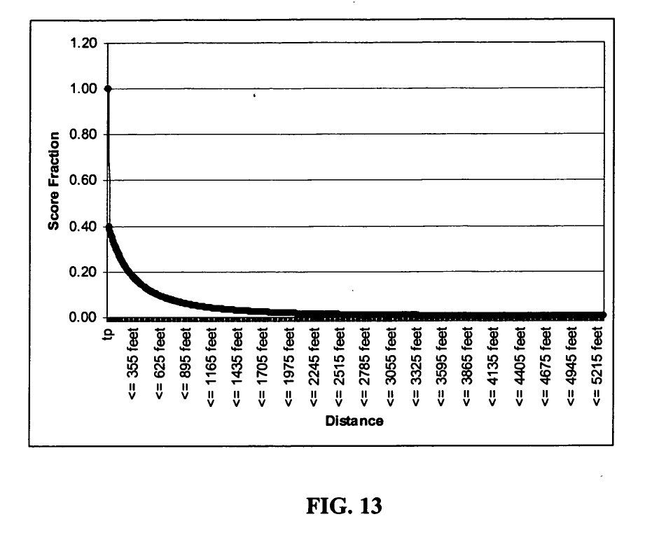

In Table A below, which exemplifies the above steps,
StatDB provides information on that status (0=open, 1=remediated).
StatSiteSCR provides a probability (fractional) multiplier based on StatDB that the status has an actual impact.
DB SCR provides a fraction multiplier based on database liability matrices (i.e., how likely a given database is to indicate significant sites).
Elev Scr adjusts score based on the probability that elevation is a factor. A decision tree—high/low elevation, status open/closed—is used. For example, a high elevation may receive a score of 1.0, while a low elevation receives a score of 0.25.
ADj score is a probability multiplier that lowers the score based on distance. A graph showing score fraction as a function of distance is provided in FIG. 13.
Dist Scr is another distance multiplier based on the probability that distance is a factor.
Yr SCR adjusts historical records by a probability score that takes into account whether the year is a factor.
Addl DB Score is another multiplier accounting for multiple linked records. It accounts for the probability that a secondary record on the same property will have some bearing on the property evaluation.
New Score is the multiplication of all factors and probabilities in a given row. One interpretation is that the NEW SCORE is the probability the record will have an impact.
The final score (not shown in Table A) is the sum of all the NEW SCORES for a given target property.
Cost Estimate is a numeric value taken from a table (see below and Table B) that compares a database type to a monetary cost.

Expected Cost is a numeric value (or range of values) computing by multiplying a New Score and a Cost Estimate.

TABLE A

| Stat- | StatSite- | DB | ELEV | ADJ | | YR | ADDL | NEW | Cost | Expected |
|---|---|---|---|---|---|---|---|---|---|---|
| DB | SCR | SCR | SCR | SCR | DIST SCR | SCR | DB SCR | SCORE | Estimate | Cost |
| 0 | 1.00 | 0.22 | 1 | 0.4 | 1 | 1 | 1 | 0.088 | $5000 | $440 |
| 0 | 1.00 | 0.22 | 1 | 0.4 | 1 | 1 | 0.05 | 0.0044 | $5000 | $22 |
| 0 | 1.00 | 0.22 | 1 | 0.4 | 0.2289325 | 1 | 0.05 | 0.0010073 | $5000 | $5 |
| 0 | 1.00 | 0.22 | 1 | 0.4 | 0.2289325 | 1 | 0.05 | 0.0010073 | $5000 | $5 |
| 0 | 1.00 | 0.22 | 1 | 0.4 | 0.2246131 | 0.9 | 1 | 0.0177894 | $5000 | $89 |
| 0 | 1.00 | 0.22 | 1 | 0.4 | 0.2123638 | 0.9 | 1 | 0.0168192 | $5000 | $84 |
| 0 | 1.00 | 0.4 | 0.25 | 0.4 | 0.1402741 | 1 | 1 | 0.005611 | $25,000 | $140 |
| 0 | 1.00 | 0.05 | 0.25 | 0.4 | 0.1402741 | 1 | 0 | 0 | $500 | $0 |
| 1 | 0.10 | 1 | 1 | 0.4 | 0.127551 | 1 | 1 | 0.005102 | $50,000 | $255 |

A Cost Estimate table, as will be recognized by those skilled in the art, may be based on expert knowledge or industry surveys, and may be cross-referenced with tabular data from the property record found in the electronic process (e.g., database type, or status). For example, a Cost Estimate table, with exact values to be determined by expert knowledge, may take the form depicted in Table B:

TABLE B

| | Cost | | Install | |
|---|---|---|---|---|
| DB Type | Estimate | Unit | Year | Status |
| UST | $2.00 | Gallon | <1990 | Open |
| UST | $1.50 | Gallon | <1990 | Closed |
| UST | $1.00 | Gallon | >1990 | Open |
| UST | $1.00 | Gallon | >1990 | Closed |
| LUST | $50,000 | Tank | — | Open |
| LUST | $25,000 | Tank | — | Closed |

Values in such a table may be compared to property records found in the record search.

Expected costs are known in the accounting field. See, e.g., FASB 143, Accounting for Asset Retirement Obligations, which can be found at fasb.org/st/summary/stsum143.shtm1, and Financial Interpretation Number 47 (FIN 47) (a supplemental interpretation of FASB 143), which can be found at fasb.org/st/summary/finsum47.shtm1.

Embodiments of the present invention comprise computer components and computer-implemented steps that will be apparent to those skilled in the art. For ease of exposition, not every step or element of the present invention is explicitly described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

For example, calculations preferably are performed by one or more computers. Moreover, notifications and other communications, as well as all data transfers, to the extent allowed by law, preferably are transmitted electronically over a computer network. Further, all data preferably is stored in one or more electronic databases, and all documents may be created using one or more computers.

Also, as those skilled in the art will recognize, the term “electronically” is used herein to refer generically to steps performed by a computer. That is, since the invention described herein is not dependent on the means of computing, the term “electronically” as used herein is intended to refer to the recited steps performed by any computer, even if that computer's operations are based on some means other than electrons flowing through circuits (there are, for example, mechanical computers and optical computers, and there may be other kinds of computers not yet developed).

While particular elements, embodiments, and applications of the present invention have been shown and described, it should be understood that the invention is not limited thereto, since modifications may be made by those skilled in the art, particularly in light of the foregoing teaching. The appended claims are intended to cover all such modifications that come within the spirit and scope of the invention.

What is claimed is:

1. A computer-based method for providing property information, comprising the steps of:
electronically receiving a request for environmental information regarding a target property, wherein said request includes data sufficient to identify said target property;
electronically searching a plurality of databases for environmental information regarding said target property and other properties located within one or more pre-determined distances of said target property;
electronically storing environmental and identifying information found in said databases related to said target property and other properties within said one or more pre-determined distances of said target property;
electronically evaluating said stored environmental and identifying information to identify environmental risk factors relating to said target property and each of said other properties;
electronically calculating one or more preliminary scores, one for said target property and one for each of said other properties; and
electronically calculating a numeric risk score for said target property based on said one or more preliminary scores.

2. A method as in claim 1, wherein said request is received over a computer network.

3. A method as in claim 1, further comprising displaying a risk-level categorization based on said risk score.

4. A method as in claim 3, wherein said risk-level categorization is further based on one or more pre-determined risk tolerance thresholds.

5. A method as in claim 1, further comprising displaying said risk score for said target property.

6. A method as in claim 1, wherein said environmental and identifying information comprises data regarding creation dates for information sources for said databases.

7. A method as in claim 1, wherein said environmental and identifying information comprises historical data regarding said target property or said other properties.

8. A method as in claim 1, wherein said evaluating step comprises comparison of said stored information to one or more environmental risk tables.

9. A method as in claim 8, wherein said environmental risk table comprises data corresponding to columns, and wherein each column corresponds to a pre-determined distance from a generic target property.

10. A method as in claim 8, wherein said preliminary scores are based at least in part on numerical values in said columns.

11. A method as in claim 8, wherein at least one of said environmental risk tables comprises data corresponding to rows, and wherein each of said rows corresponds to a database.

12. A method as in claim 8, wherein at least one of said environmental risk tables comprises data corresponding to rows, and wherein each of said rows corresponds to a keyword.

13. A method as in claim 1, further comprising calculating an adjusted score for said target property and each of said other properties, wherein each adjusted score is based on a corresponding preliminary score and wherein said risk score is further based on said adjusted scores.

14. A method as in claim 13, wherein said adjusted score for each property is based at least in part on a site status of one or more environmental risk factors for that property.

15. A method as in claim 13, wherein said adjusted score for each property of said other properties is based at least in part on a comparison of elevation of that property to elevation of said target property.

16. A method as in claim 13, wherein said adjusted score for each property is based at least in part on soil and geologic characteristics for that property.

17. A method as in claim 13, wherein said adjusted score for each property is based at least in part on health risks for that property.

18. A method as in claim 13, wherein said adjusted score for each property is based at least in part on historical factors regarding that property.

19. A method as in claim 1, wherein said evaluating step comprises calculating a probability or range of probabilities regarding one or more of said factors.

20. A method as in claim 13, wherein said adjusted score is based at least in part on estimated costs.

21. A method as in claim 1, wherein said step of electronically searching a plurality of databases comprises vectorizing a fire insurance map collection.

22. A method as in claim 1, wherein said step of electronically searching a plurality of databases comprises converting scanned maps to a set of GIS lines.

23. A method as in claim 1, wherein said step of electronically searching a plurality of databases comprises searching for a numeric code in a GIS database.

24. A method as in claim 1, wherein said step of electronically searching a plurality of databases comprises searching raster-scanned Fire Insurance Map images using GIS technology or optical character recognition.

25. A method as in claim 1, wherein said step of electronically searching a plurality of databases comprises searching printed Fire Insurance Map images using GIS technology or optical character recognition.

26. A method as in claim 1, wherein said step of electronically searching a plurality of databases comprises searching a database of manually abstracted Fire Insurance Map images using GIS technology, optical character recognition, or keywords.

27. Computer software for providing property information, comprising:
software for electronically receiving a request for environmental information regarding a target property, wherein said request includes data sufficient to identify said target property;
software for electronically searching a plurality of databases for environmental information regarding said target property and other properties located within one or more pre-determined distances of said target property;
software for electronically storing environmental and identifying information found in said databases related to said target property and other properties within said one or more pre-determined distances of said target property;
software for electronically evaluating said stored environmental and identifying information to identify environmental risk factors relating to said target property and each of said other properties;
software for electronically calculating one or more preliminary scores, one for said target property and one for each of said other properties; and
software for electronically calculating a numeric risk score for said target property based on said one or more preliminary scores.

28. A computer system programmed to:
receive a request for environmental information regarding a target property, wherein said request includes data sufficient to identify said target property;
search a plurality of databases for environmental information regarding said target property and other properties located within one or more pre-determined distances of said target property;
store environmental and identifying information found in said databases related to said target property and other properties within said one or more pre-determined distances of said target property;
evaluate said stored environmental and identifying information to identify environmental risk factors relating to said target property and each of said other properties;
calculate one or more preliminary scores, one for said target property and one for each of said other properties; and
calculate a numeric risk score for said target property based on said one or more preliminary scores.
